(19) United States
(12) Patent Application Publication
(10) Pub. No.: US 2010/0229190 A1
(43) Pub. Date: Sep. 9, 2010

(54) CONTENT RECOMMENDING METHOD AND APPARATUS THEREFOR

(75) Inventors: Min-soo KOO, Seoul (KR); Moon-sang Lee, Suwon-si (KR)

Correspondence Address: STAAS & HALSEY LLP, SUITE 700, 1201 NEW YORK AVENUE, N.W., WASHINGTON, DC, 20005, US

(73) Assignee: Samsung Electronics Co., Ltd., Suwon-si (KR)

(21) Appl. No.: 12/554,140

(22) Filed: Sep. 4, 2009

(30) Foreign Application Priority Data
Mar. 5, 2009 (KR) 10-2009-0018913

(51) Int. Cl. H04N 7/16

(52) U.S. Cl. 725/14

(57) ABSTRACT

A content recommending method and apparatus therefor. The content recommending method involves obtaining location information by tracing movement of a user; analyzing a preference of the user by using the location information; and selecting content to be provided to the user according to the preference.

### CROSS-REFERENCE TO RELATED APPLICATION

This application claims the benefit of Korean Patent Application No. 10-2009-0018913, filed in the Korean Intellectual Property Office on Mar. 5, 2009, the disclosure of which is incorporated herein by reference.

### BACKGROUND OF THE INVENTION

1. Field of the Invention

Aspects of the present invention relate to content provision, and more particularly, to a content recommending method and apparatus therefor so as to recommend content according to user preference.

2. Description of the Related Art

In a content recommending system, two methods are generally used to recommend new content to a user. The first method to recommend content is by referring to the frequency of content use. The first method is used in conventional Internet Protocol Televisions (IPTVs) that select and recommend new content by analyzing a type of user preferred content according to a history log having stored therein information about movies, music, and the like, viewed by the user. However, the first method takes a long time to accumulate a content use history that allows the user preference to be analyzed, and is inappropriate for recommending content to a new user. The second method to recommend content is by referring to user preference. The user directly inputs content categories preferred by the user, and new content is recommended according to the content categories. The second method outputs a highly correct result, however, it is difficult to guide a user to directly input the user preference.

### SUMMARY OF THE INVENTION

Aspects of the present invention provide a content recommending method and apparatus therefor which may select user preferred content without referring to a content use history or inputting preference.

According to an aspect of the present invention, a content recommending method is provided. The method includes tracing movement of a mobile device corresponding to a user and obtaining location information of the user based on the traced movement; analyzing a preference of the user based on the location information; and selecting content to be provided to the user according to the analyzed preference.

According to another aspect of the present invention, when the user stays at a location within a predetermined distance range for at least a predetermined period of time, the obtaining of the location information may include obtaining address information indicating the location.

According to another aspect of the present invention, the analyzing of the preference may include determined an activity related to the location based on the address information; and selecting a content category matching the determined activity.

According to another aspect of the present invention, the obtaining of the address information may include collecting Global Positioning System (GPS) coordinate data with respect to the movement of the mobile device; extracting valid data from the GPS coordinate data, wherein the valid data indicates the location where the user remains for at least the predetermined period of time; and converting the valid data into the address information.

According to another aspect of the present invention, a content recommending apparatus is provided. The content recommendation apparatus including a location information obtaining unit to trace movement of a mobile device corresponding to a user and to obtain location information of the user based on the traced movement; a preference analyzing unit to analyze a preference of the user based on the location information; and a content providing unit to select content to be provided to the user according to the preference.

Additional aspects and/or advantages of the invention will be set forth in part in the description which follows and, in part, will be obvious from the description, or may be learned by practice of the invention.

### BRIEF DESCRIPTION OF THE DRAWINGS

These and/or other aspects and advantages of the invention will become more apparent and more readily appreciated from the following description of the embodiments, taken in conjunction with the accompanying drawings of which:

FIG. 1 illustrates a content recommending method according to an embodiment of the present invention;

FIG. 2 illustrates a content recommending system according to an embodiment of the present invention;

FIG. 3 is a flowchart of a content recommending method according to an embodiment of the present invention;

FIG. 4 is a flowchart of a content recommending method according to another embodiment of the present invention; and

FIG. 5 is a diagram of operations of the content recommending method of FIG. 4.

### DETAILED DESCRIPTION OF THE EMBODIMENTS

Hereinafter, the present invention will now be described in detail by explaining exemplary embodiments of the invention with reference to the attached drawings. Reference will now be made in detail to the present embodiments of the present invention, examples of which are illustrated in the accompanying drawings, wherein like reference numerals refer to the like elements throughout. The embodiments are described below in order to explain the present invention by referring to the figures.

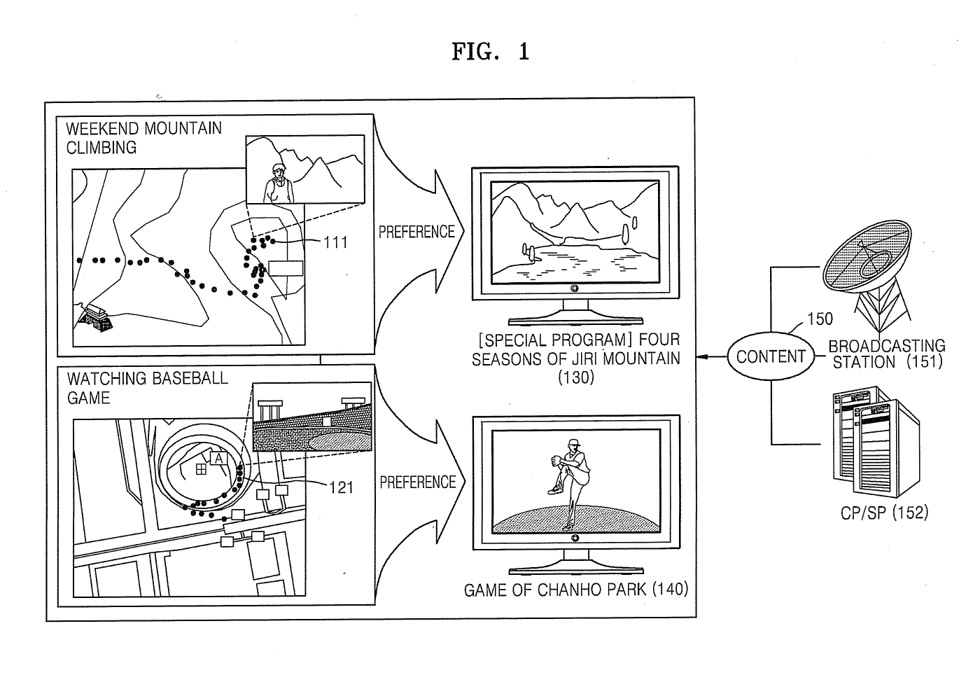

FIG. 1 illustrates a content recommending method according to an embodiment of the present invention. The content recommending method involves tracing movement of a user carrying a device having installed a Global Positioning System (GPS) receiver, analyzing content preference of the user according to the movement, and recommending content 150 according to the content preference.

Referring to FIG. 1, a user is hiking Bukhan mountain with the device, and GPS coordinates 111 are logged accordingly. A broadcasting station 151, or a server 152 operated by a content provider (or, a service provider) analyzes the logged data received from the device, and predicts that the user would prefer content about mountains since the user is hiking a mountain. The logged data can be stored in the mobile device and later uploaded to the station 151 or server 152, or the GPS information 111 can be sent and stored as a log at the station 151 or server 152. Therefore, the broadcasting station 151 or the server 152 recommends by providing ‘the four seasons of Jiri mountain’ 130, which is content matching a result of the prediction. In a different case where the GPS coordinates 121 indicating a baseball stadium are logged, the broadcasting station 151 or the server 152 predicts that a user would prefer sports content, in particular, baseball content, and thus, recommends by providing ‘a game of Chanho PARK’ 140, which is content matching a result of the prediction.

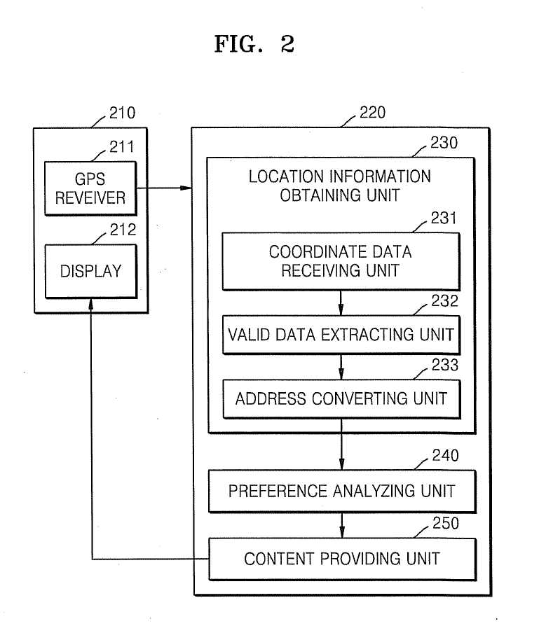

FIG. 2 illustrates a content recommending system, according to an embodiment of the present invention. As shown in FIG. 2, a content recommending apparatus 220 selects and provides user preferred content to a mobile content reproducing apparatus 210 having installed therein a GPS receiver 211 and a display 212. The mobile content recommending apparatus 220 may be a cellular telephone, personal digital assistant, personal entertainment device, multi-function mobile device, or other mobile device. Similarly, the content recommending system may be implemented as a server in a mobile communication system, as a host apparatus, or other device.

Although the content is video shown on a display 212 in FIG. 2, the video could be reproduced on a separate display. Further, where the content is not video or image based, the content may be reproduced via an appropriate output device, such as a speaker for recommended audio content.

GPS coordinate data received by the GPS receiver 211 is analyzed by a location information obtaining unit 230 so as to obtain location information about a place where a user is located. While not required, the GPS coordinate data can be transmitted between the GPS receiver 211 and the data receiving unit 231 shown in FIG. 2 using wired and/or wireless techniques. While not required in all aspects, the location information obtaining unit 230 as shown in FIG. 2 includes the coordinate data receiving unit 231, a valid data extracting unit 232, and an address converting unit 233. The coordinate data receiving unit 231 receives the GPS coordinate data collected by movement of the user. The valid data extracting unit 232 extracts valid data from the GPS coordinate data. The valid data indicates a place where the user has stayed for longer than a predetermined period of time. The address converting unit 233 converts the valid data into address information about the place where the user has stayed.

A preference analyzing unit 240 determines which activity is related to the place according to the address information obtained by the location information obtaining unit 230, and predicts a content category possibly preferred by the user according to the activity. A content providing unit 250 recommends contents of the predicted content category to the user. When the user selects content from among the recommended contents, the content providing unit 250 provides the selected content to the mobile content reproducing apparatus 210 that then reproduces the selected content on the display 212. Thus, one or more of the coordinate data receiving unit 231, the valid data extracting unit 232, the address converting unit 233 and the preference analyzing unit 240 may be included in the mobile content reproducing apparatus 210.

According to the content recommending system of FIG. 2, the content recommending apparatus 220 corresponding to a content providing server obtains the location information by analyzing the GPS coordinate data, performs a preference analysis based on the location information, and provides content. However, the content recommending system may be implemented in such a manner that the mobile content reproducing apparatus 210 corresponding to a client obtains the location information, performs the preference analysis, and transmits preference information to the content recommending apparatus 220, and the content recommending apparatus 220 provides content according to the received preference information.

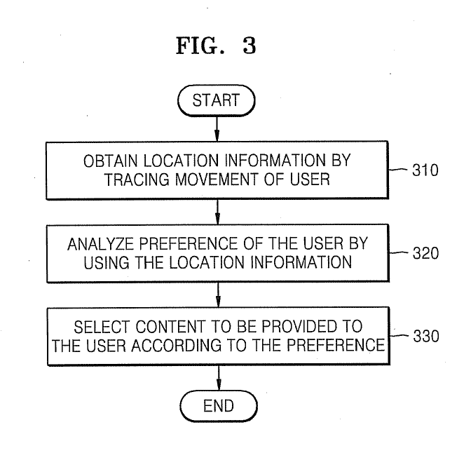

FIG. 3 is a flowchart of a content recommending method according to an embodiment of the present invention. Movement of a user is traced in operation 310 so that location information of the user is obtained. In the case where the user stays at a location within a predetermined distance range for longer than a predetermined period of time, the location information may be address information indicating the location. The preference of the user is analyzed in operation 320 based on the location information. The analysis of the preference of the user may be performed by analyzing an activity of the user related to the user's location based on the address information, and by selecting a content category corresponding to the activity. For example, in the case where a user stays at a ski resort for longer than a predetermined period of time, the user would likely prefer contents about skiing or snowboarding, such as a ski movie or content about the winter Olympic games. Content to be provided to the user is selected in operation 330 based on the analyzed preference.

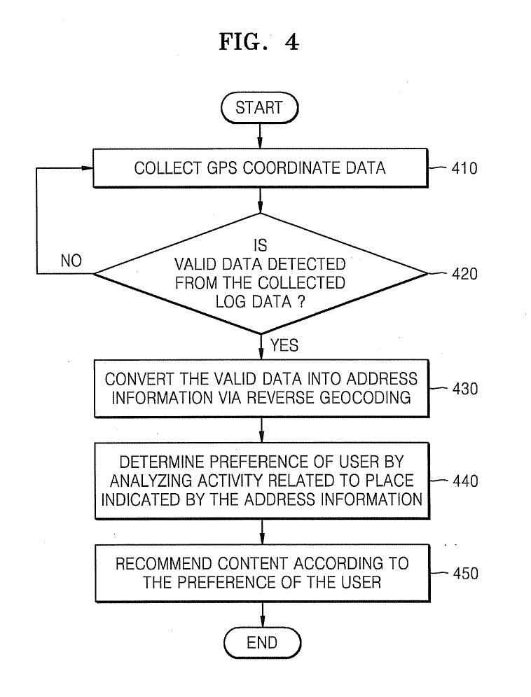

FIG. 4 is a flowchart of a content recommending method according to another embodiment of the present invention. GPS coordinate data is collected in operation 410 so as to trace movement of a user. Logged GPS information may include geographical coordinate data and information about a time at which the geographical coordinate data is generated. Valid data is extracted from the collected GPS coordinate data in operation 420. The valid data indicates information about a place where the user actually performs an activity. In order to extract the valid data, logs, which are recorded while the user moves to a specific place for an activity or mistakenly recorded, are filtered.

For example, in the case where a user moves within a predetermined range of areas for a predetermined period of time (such as an indoor park, a mountain, an outdoor theme park, and the like), only GPS coordinates of the aforementioned places are included in the valid data. Where a user remains at an entrance of a building (such as a theater, a large mall, an indoor gymnasium, and the like), and then enters the building (i.e., the inside of the building), only GPS coordinate data corresponding to the building is extracted as the valid data. Techniques of extracting the valid data are not limited to the aforementioned cases; other methods may be used to extract the valid data. If the valid data is not extracted from the collected GPS coordinate data, other GPS coordinate data is continuously collected or a collecting operation is ended in operation 420.

The extracted valid data is converted into address information in operation 430. A method called Reverse Geocoding may be used to convert the GPS coordinate data into an address. However, techniques of converting the valid data into the address information is not limited to Reverse Geocoding. As a result of the Reverse Geocoding or other conversion process, the address and a time are output. Additional information about altitude, speed, and the like, may also be output. The preference of the user is determined from the address information in operation 440. Activities related to the place corresponding to the address are determined, including particular activities performed at the location. Based on a result of the analysis, the preference of the user is determined. Content is selected according to the preference and is recommended to the user in operation 450.

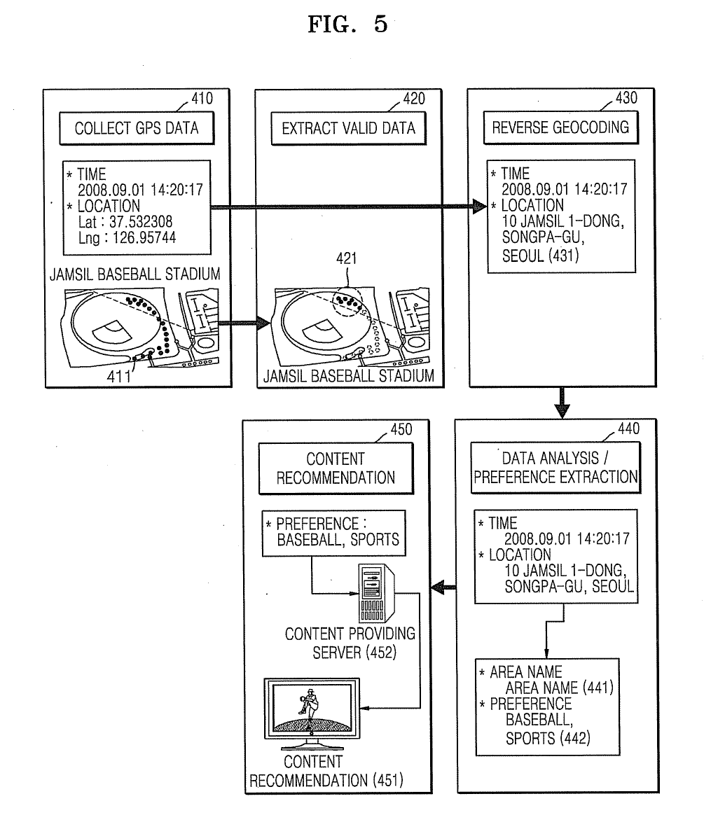

FIG. 5 is a diagram of operations of the content recommending method of FIG. 4. GPS coordinates 411 collected in operation 410 are shown in FIG. 5. In operation 420, only valid data 421 is extracted from among the GPS coordinates 411. The user is determined to be staying in an area within a predetermined range for over a predetermined period of time at 14:20:17 (time), Sep. 1, 2008 (date). A location where the user stays and performs an activity corresponds to coordinates indicating a latitude of 37.532308 and a longitude of 126.95744. In operation 430, the valid data 421 is converted into an address 431 that is ‘10 Jamsil 1-dong, Songpa-gu, Seoul’. In operation 440, the address 431 is determined to indicate an area name 441 called ‘Jamsil baseball stadium’, and as a result of the determination, user preference information 442 is generated with respect to ‘baseball’ and ‘sports’. Additionally and while not required, since the time and date is known, if information on the teams then playing is available (such as through an online baseball schedule), the user preference information 442 can be further refined to recommend specific teams since it can be determined that the user was watching specific baseball teams at Jamsil baseball stadium.

In operation 450, the user preference information 442 is transmitted to a content providing server 452, and the content providing server 452 recommends content 451 of a content category matching the user preference information 442. In this manner, outdoor activities of the user may be automatically analyzed and be reflected on content recommendation for the user, and a more exact analysis with respect to the user preference may be performed. While described in terms of video content, the recommended content may be any type of content, including audio, images, text, software, and the like.

Aspects of the present invention can also be embodied as computer readable code on a computer readable recording medium. The computer readable recording medium is any data storage device that can store data which can be thereafter read by a computer system. Examples of the computer readable recording medium include read-only memory (ROM), random-access memory (RAM), CD-ROMs, magnetic tapes, floppy disks, and optical data storage devices. The computer readable recording medium can also be distributed over network coupled computer systems so that the computer readable code is stored and executed in a distributed fashion.

Although a few embodiments of the present invention have been shown and described, it will be understood by those skilled in the art that changes may be made in this embodiment without departing from the principles and spirit of the present invention, the scope of which is defined by the following claims and their equivalents.

What is claimed is:

1. A content recommending method comprising:
tracing movement of a mobile device corresponding to a user and obtaining location information of the user based on the traced movement;
analyzing a preference of the user based on the obtained location information; and
selecting content to be provided to the user according to the analyzed preference.

2. The content recommending method of claim 1, wherein, when the user remains at a location within a predetermined distance range for at least a predetermined period of time, the obtaining of the location information comprises obtaining address information indicating the location.

3. The content recommending method of claim 2, wherein the analyzing of the preference comprises:
determining an activity related to the location based on the address information; and
selecting a content category matching the determined activity.

4. The content recommending method of claim 2, wherein the obtaining of the address information comprises:
collecting GPS (Global Positioning System) coordinate data with respect to the movement of the mobile device;
extracting valid data from the collected GPS coordinate data, wherein the valid data indicates the location where the user stays for at least the predetermined period of time; and
converting the valid data into the address information.

5. A computer readable recording medium having recorded thereon a program to execute a content recommending method using one or more processors, the content recommending method comprising:
tracing movement of a mobile device corresponding to a user and obtaining location information of the user based on the traced movement;
analyzing a preference of the user based on the obtained location information; and
selecting content to be provided to the user according to the analyzed preference.

6. A content recommending apparatus comprising:
a location information obtaining unit to trace movement of a mobile device corresponding to a user and to obtain location information of the user based on the traced movement;
a preference analyzing unit to analyze a preference of the user based on the obtained location information; and
a content providing unit to select content to be provided to the user according to the analyzed preference and to provide the selected content.

7. The content recommending apparatus of claim 6, wherein, when the user stays at a location within a predetermined distance range for at least a predetermined period of time, the location information obtaining unit obtains address information indicating the location.

8. The content recommending apparatus of claim 7, wherein the preference analyzing unit analyzes an activity related to the location based on the address information, and selects a content category matching the activity.

9. The content recommending apparatus of claim 7, wherein the location information obtaining unit comprises:
a coordinate data receiving unit to collect GPS (Global Positioning System) coordinate data with respect to the movement of the user;
a valid data extracting unit to extract valid data from the collected GPS coordinate data, wherein the valid data indicates the location where the user stays for longer than the predetermined period of time; and
an address converting unit to convert the extracted valid data into the address information.

10. A mobile device comprising:
a Global Positioning System (GPS) receiver to obtain location information of the mobile device;
a content recommending unit to select content based on the obtained location information
a receiving unit to retrieve the selected content from a content provider based on the selection of the content recommending unit; and
an output unit to provide the retrieved content.

11. The mobile device of claim 10, wherein the content recommending unit comprises:
a location obtaining unit to obtain a location of the user based on the location information obtained by the GPS receiver;
a preference analyzing unit to determine a preference of the user based on the obtained location; and
a content selecting unit to select content based on the analyzed preference.

12. The mobile device of claim 11, wherein the location information obtaining unit comprises:
a coordinate data receiving unit to extract coordinate data from the obtained location information;
a valid data extraction unit to extract valid data from the extracted coordinate data, the valid data indication a location where the user remains in substantially the same place for at least a predetermined period of time; and
an address converting unit to convert the extracted valid data into address information and to set the location as an address identified in the address information.

13. The content recommending method of claim 1, further comprising:
transmitting the selected content to the mobile device

14. The content recommending apparatus of claim 6, wherein:
the location information obtaining unit receives the location information from the mobile device.

15. The content recommending apparatus of claim 6, wherein:
the content providing unit provides the selected content to the mobile device.
